(19) United States
(12) Patent Application Publication
(10) Pub. No.: US 2026/0075433 A1
(43) Pub. Date: Mar. 12, 2026

(54) ELECTRONIC DEVICE AND METHOD FOR SECONDARY USERS AND SPECTRUM MANAGEMENT APPARATUS, AND STORAGE MEDIUM

(71) Applicant: Sony Group Corporation, Tokyo (JP)

(72) Inventors: Cong DONG, Chengdu, Sichuan (CN); Jingwei YE, Chengdu, Sichuan (CN); Yingchang LIANG, Chengdu, Sichuan (CN); Shuo WANG, Beijing (CN); Chen SUN, Beijing (CN)

(73) Assignee: Sony Group Corporation, Tokyo (JP)

(21) Appl. No.: 19/125,324

(22) PCT Filed: Oct. 31, 2023
(86) PCT No.: PCT/CN2023/128072

§ 371 Date: Apr. 29, 2025

(30) Foreign Application Priority Data
Nov. 7, 2022 (CN) 202211383173.7

(51) Int. Cl. H04W 16/14

(52) U.S. Cl. CPC H04W 16/14

(57) ABSTRACT

In a dynamic spectrum management apparatus, system, method, and computer program product first and second priority level secondary users dynamically use spectrum resources of a primary user. For second priority level secondary users, processing circuitry is configured to, based on blockchain, obtain a spectrum coordination request, acknowledged by a spectrum management apparatus, of another second priority level secondary user serving as a requester for the spectrum resources, wherein the blockchain at least comprises each second priority level secondary user, who is using or requests the use of the spectrum resources, serving as a node, and the spectrum coordination request indicates that the requester makes a request for the second priority level secondary user, who is using the spectrum resources, to perform coordination to provide an interference margin for the requester; and execute a first smart contract on the blockchain, so as to determine content of coordination to be performed.

This application claims the priority to Chinese Patent Application No. 202211383173.7, titled “ELECTRONIC DEVICE AND METHOD FOR SECONDARY USERS AND SPECTRUM MANAGEMENT APPARATUS, AND STORAGE MEDIUM”, filed on Nov. 7, 2022 with the China National Intellectual Property Administration (CNIPA), which is incorporated herein by reference in its entirety.

### TECHNICAL FIELD

Embodiments of the present disclosure generally relate to the field of wireless communications, in particular to dynamic spectrum sharing coordination technology, and more specifically, to an electronic device and a method for a second priority level secondary user, a first priority level secondary user, and spectrum management apparatus in a dynamic spectrum sharing system, and a computer-readable storage medium.

### BACKGROUND

With the application of 5G technology, network base stations are deployed more densely. At the same time, the number of terminals of various forms, such as mobile phones, IoT devices, and wearable devices, has increased dramatically. The requirement for spectrum resources, especially for frequency bands below 6 GHz suitable for mobile communications, is larger and larger. Due to the heterogeneity and dynamic nature of services, the traditional static spectrum management scheme has low spectrum utilization rate and wastes precious spectrum resources. Therefore, the dynamic spectrum sharing technology has been proposed, in which secondary users discover the idle spectrum of primary users through spectrum sensing or database for transmission, to improve spectrum utilization rate.

For example, Citizens Broadband Radio Service (CBRS) is a spectrum allocation model defined by the Federal Communications Commission (FCC) of the United States, which allows different users to dynamically share up to 150 MHz of spectrum in the 3.5 GHz frequency band, resulting lower cost than the traditional exclusive use mode. The CBRS system defines three tiers of user spectrum usage rights: Incumbents, Priority Access License (PAL) users, and General Authorized Access (GAA) users.

Currently, the CBRS system dynamically allocates spectrum through a centralized Spectrum Access System (SAS). The number of users is increasing and all the Citizens Broadband radio Service Devices (CBSD) in the system need to send relevant messages to the SAS, resulting in the tremendous management pressure of SAS and existence of the problem of single-point failure.

In addition, the CBRS system proposes a PAL Protection Area (PPA) to ensure that PAL users will not be subjected to harmful interferences during usage, that is, within the PPA, the aggregate interferences that the PAL users are subjected to cannot exceed the interference threshold. In the prior art, it has been considered to allow the GAA users to share the frequency band of PAL users so as to make full use of the frequency band of PAL users, but the problem of PAL user interference thresholds coordination caused by multiple GAA users using the frequency band of PAL users in a licensed area and the processing method thereof are not considered.

### SUMMARY

A brief overview of the disclosure is given below in order to provide a basic understanding of certain aspects of the disclosure. It should be understood that this overview is not an exhaustive overview of the disclosure. It is not intended to identify key or important parts of the disclosure, nor is it intended to limit the scope of the disclosure. Its purpose is simply to give certain concepts in a simplified form as a prelude to a more detailed description discussed later.

According to an aspect of the present application, an electronic device for a second priority level secondary user in a dynamic spectrum sharing system is provided, the dynamic spectrum sharing system including a primary user, a first priority level secondary user and the second priority level secondary user, the first priority level secondary user and the second priority level secondary user dynamically utilizing the spectrum resources of the primary user, and in terms of utilizing the spectrum resources of the primary user, the first priority level is higher than the second priority level, the electronic device including: a processing circuit configured to: acquire, based on a block chain, a spectrum coordination request confirmed by a spectrum management apparatus from another second priority level secondary user who is a requester for spectrum resources, wherein the block chain at least includes each second priority level secondary user who is utilizing or requesting to utilize the spectrum resources as a node, the spectrum coordination request indicating that the requester requests the second priority level secondary users who are utilizing the spectrum resources to perform coordination to provide an interference margin for the requester; and execute a first smart contract on the block chain to determine the content of the coordination to be performed.

According to another aspect of the present application, a method for a second priority level secondary user in a dynamic spectrum sharing system is provided, the dynamic spectrum sharing system including a primary user, a first priority level secondary user and the second priority level secondary user, the first priority level secondary user and the second priority level secondary user dynamically utilizing the spectrum resources of the primary user, and in terms of utilizing the spectrum resources of the primary user, the first priority level is higher than the second priority level, the method including: acquiring, based on a block chain, a spectrum coordination request confirmed by a spectrum management apparatus from another second priority level secondary user who is a requester for spectrum resources, wherein the block chain at least includes each second priority level secondary user who is utilizing or requesting to utilize the spectrum resources as a node, the spectrum coordination request indicating that the requester requests the second priority level secondary users who are utilizing the spectrum resources to perform coordination to provide an interference margin for the requester; and executing a first smart contract on the block chain to determine the content of the coordination to be performed.

The electronic device and method according to the above aspects of the present application provide a corresponding interference margin by causing the second priority level secondary users who are utilizing spectrum resources to perform coordination, so that new second priority level secondary users can successfully access in the spectrum resources, thereby improving the efficiency of dynamic spectrum sharing.

According to an aspect of the present application, an electronic device for a first priority level secondary user in a dynamic spectrum sharing system is provided, the dynamic spectrum sharing system including a primary user, a first priority level secondary user and a second priority level secondary user, the first priority level secondary user and the second priority level secondary user dynamically utilizing the spectrum resources of the primary user, and in terms of utilizing the spectrum resources of the primary user, the first priority level is higher than the second priority level, the electronic device including: a processing circuit configured to: receive, from the second priority level secondary user who is a requester for the spectrum resources, the content of coordination to be performed by other second priority level secondary users participating in the coordination, wherein the requester requests other second priority level secondary users who are utilizing the spectrum resources to perform coordination to provide an interference margin for the requester; forward the content of coordination to another first priority level secondary user utilizing the spectrum resources; receive, from affected another first priority level secondary user, information of whether to agree to increase its own interference threshold; and transmit a response to the requester based on the information.

According to another aspect of the present application, a method for a first priority level secondary user in a dynamic spectrum sharing system is provided, the dynamic spectrum sharing system including a primary user, a first priority level secondary user and a second priority level secondary user, the first priority level secondary user and the second priority level secondary user dynamically utilizing the spectrum resources of the primary user, and in terms of utilizing the spectrum resources of the primary user, the first priority level is higher than the second priority level, the method including: receiving, from a second priority level secondary user who is a requester for the spectrum resources, the content of coordination to be performed by other second priority level secondary users participating in the coordination, wherein the requester requests other second priority level secondary users who are utilizing the spectrum resources to perform coordination to provide an interference margin for the requester; forwarding the content of coordination to another first priority level secondary user utilizing the spectrum resources; receiving, from affected another first priority level secondary user, information of whether to agree to increase its own interference threshold; and transmitting a response to the requester based on the information.

The electronic device and method according to the above aspects of the present application improve the performance of dynamic spectrum sharing by performing interference coordination among multiple first priority level secondary users.

According to an aspect of the present application, an electronic device for a spectrum management apparatus in a dynamic spectrum sharing system is provided, the dynamic spectrum sharing system including a primary user, a first priority level secondary user and a second priority level secondary user, the first priority level secondary user and the second priority level secondary user dynamically utilize the spectrum resources of the primary user, and in terms of utilizing the spectrum resources of the primary user, the first priority level is higher than the second priority level, the electronic device including: a processing circuit, configured to: receive, from a second priority level secondary user as a requester for the spectrum resources, information indicating that the requester accepts spectrum coordination, through which other second priority level secondary users who are utilizing the spectrum resources perform coordination to provide an interference margin for the requester; and transmit a spectrum coordination request confirmed by the spectrum management apparatus to the requester.

According to another aspect of the present application, a method for a spectrum management apparatus in a dynamic spectrum sharing system is provided, the dynamic spectrum sharing system including a primary user, a first priority level secondary user and a second priority level secondary user, the first priority level secondary user and the second priority level secondary user dynamically utilize the spectrum resources of the primary user, and in terms of utilizing the spectrum resources of the primary user, the first priority level is higher than the second priority level, the method including: receiving, from a second priority level secondary user as a requester for the spectrum resources, information indicating that the requester accepts spectrum coordination, through which other second priority level secondary users who are utilizing the spectrum resources perform coordination to provide an interference margin for the requester; and transmitting a spectrum coordination request confirmed by the spectrum management apparatus to the requester.

The electronic device and method according to the above aspects of the present application provide a corresponding interference margin by causing second priority level secondary users who are utilizing spectrum resources to perform coordination, so that new second priority level secondary users can successfully access in the spectrum resources, thereby improving the efficiency of dynamic spectrum sharing.

According to other aspects of the present disclosure, a computer program code and a computer program product for implementing the above method and a computer-readable storage medium having the computer program code for implementing the above method recorded thereon are also provided.

The above and other advantages of the present disclosure will become more apparent through the following detailed description of the preferred embodiments of the present disclosure in conjunction with the accompanying drawings.

### BRIEF DESCRIPTION OF THE DRAWINGS

In order to further illustrate the above and other advantages and features of the present disclosure, the specific embodiments of the present disclosure are further described in detail below in conjunction with the accompanying drawings. The accompanying drawings together with the following detailed description are included in this specification and form a part of this specification. Elements with the same function and structure are represented by the same reference numerals. It should be understood that these drawings only describe typical examples of the present disclosure and should not be regarded as limiting the scope of the present disclosure. In the drawings:

FIG. 1 shows a schematic scenario of a CBRS system;

FIG. 2 shows a functional module block diagram of an electronic device for a second priority level secondary user according to an embodiment of the present application;

FIG. 3 shows an information flow diagram of the process that a requesting GAA requests for coordination;

FIG. 4 shows an information flow diagram of the coordination process between the existing GAA and PAL;

FIG. 5 shows an information flow diagram of a process that the requesting GAA is granted to access in spectrum;

FIG. 6 shows an information flow diagram of updating of trust values;

FIG. 7 shows an information flow diagram of the consensus process of the block chain;

FIG. 8 shows an example of a block generated by an accounting node;

FIG. 9 shows a functional module block diagram of an electronic device for a first priority level secondary user according to another embodiment of the present application;

FIG. 10 shows a functional module block diagram of an electronic device for a spectrum management apparatus according to another embodiment of the present application;

FIG. 11 shows a functional module block diagram of an electronic device for a spectrum management apparatus according to another embodiment of the present application;

FIG. 12 shows a flow chart of a method for a second priority level secondary user according to an embodiment of the present application;

FIG. 13 shows a flowchart of a method for a first priority level secondary user according to another embodiment of the present application;

FIG. 14 shows a flow chart of a method for a spectrum management apparatus according to another embodiment of the present application;

FIG. 15 is a block diagram illustrating a first example of a schematic configuration of an eNB or gNB to which the technology of the present disclosure may be applied;

FIG. 16 is a block diagram illustrating a second example of a schematic configuration of an eNB or gNB to which the technology of the present disclosure may be applied;

FIG. 17 is a block diagram illustrating an example of a schematic configuration of a server; and

FIG. 18 is a block diagram of an exemplary structure of a general-purpose personal computer in which the method and/or apparatus and/or system according to an embodiment of the present disclosure may be implemented.

### DETAILED DESCRIPTION

Exemplary embodiments of the present disclosure will be described below in conjunction with the accompanying drawings. For the sake of clarity and conciseness, not all features of the actual implementation are described in the specification. However, it should be understood that many implementation-specific decisions must be made in the process of developing any such actual implementation in order to achieve the developer's specific goals, such as meeting those constraints related to the system and business, and these constraints may vary from implementation to implementation. In addition, it should be understood that although the development work may be very complex and time-consuming, it is only a routine task for those skilled in the art who benefit from the content of this disclosure.

It is also necessary to explain here that, in order to avoid obscuring the present disclosure due to unnecessary details, only the device structure and/or processing steps closely related to the scheme according to the present disclosure are shown in the accompanying drawings, while other details that are not very relevant to the present disclosure are omitted.

### First Embodiment

As mentioned above, in order to improve the spectrum utilization rate, a dynamic spectrum sharing technology is proposed. In the dynamic spectrum sharing, it is necessary to consider the coexistence of different wireless communication systems using the same frequency or adjacent frequencies and the protection of the primary system (hereinafter also referred to as the primary user).

For example, a dynamic spectrum sharing system may include a primary user, a first priority level secondary user, and a second priority level secondary user, the first priority level secondary user and the second priority level secondary user dynamically utilize the spectrum resources of the primary user, and in terms of utilizing the spectrum resources of the primary user, the first priority level is higher than the second priority level. These terms are applicable throughout the specification and will not be repeated hereinafter. For example, in the CBRS system mentioned above, the incumbent is the primary user, the PAL user is the first priority level secondary user, the GAA user is the second priority level secondary user, and the first priority level secondary user and the second priority level secondary user may be, for example, a TDD-LTE, 5G NR system, etc.

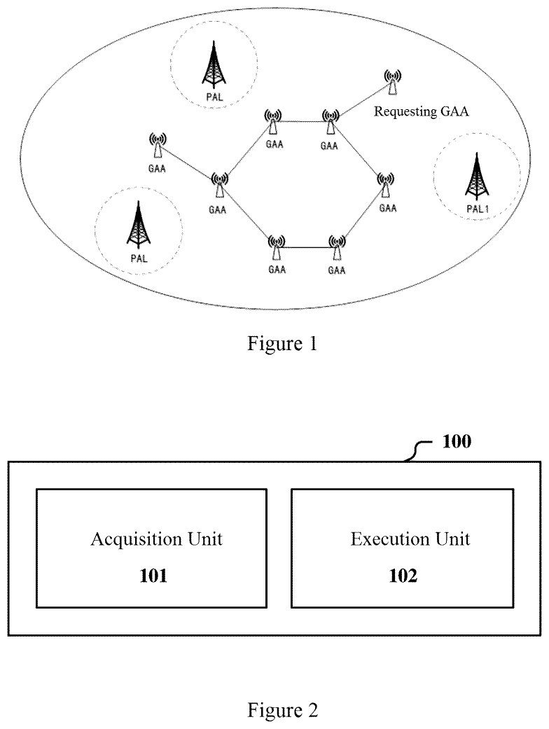

FIG. 1 shows a schematic scenario diagram of a CBRS system, in which a plurality of PAL users and a plurality of GAA users are deployed in a spectrum licensed area shown by an ellipse, a plurality of GAA users are utilizing spectrum resources, and a requesting GAA is requesting to access in spectrum resources. The description below can be understood with reference to the CBRS system and the scenario diagram of FIG. 1, but it should be noted that the embodiments of the present application are not limited to application to a CBRS system, but can be applied to any dynamic spectrum sharing system in which secondary users have priority level distinctions. Furthermore, the number of priority levels is not limited to two levels, but can have more levels.

FIG. 2 shows a functional module block diagram of an electronic device 100 for a second priority level secondary user in a dynamic spectrum sharing system according to an embodiment of the present application. As shown in FIG. 2, the electronic device 100 includes: an acquisition unit 101, configured to acquire, based on a block chain, a spectrum coordination request from another second priority level secondary user as a requester for the spectrum resources, which is confirmed by a spectrum management apparatus, wherein the block chain at least includes each second priority level secondary user which is utilizing or requesting to utilize the spectrum resources as a node, and the spectrum coordination request indicates that the requester requests the second priority level secondary users who are utilizing the spectrum resources to perform coordination to provide an interference margin for the requester; and an execution unit 102, configured to execute a first smart contract on the block chain to determine the content of the coordination to be performed.

The acquisition unit 101 and the execution unit 102 may be implemented by one or more processing circuits, which may be implemented as a chip or a processor, for example. In addition, it should be understood that the various functional units in the electronic device shown in FIG. 2 are only logical modules divided according to the specific functions implemented by them, and are not used to limit the specific implementation form.

The electronic device 100 can be provided on the second priority level secondary user side, for example, on its base station side or communicatively connected to the base station. Here, it should also be pointed out that the electronic device 100 can be implemented at the chip level, or it can also be implemented at the device level. For example, the electronic device 100 can work as the base station itself, and can also include external devices such as memory, transceiver (not shown in the figure). The memory can be used to store programs and related data information required by the electronic device to implement various functions. The transceiver may include one or more communication interfaces to support communication with different devices (for example, other base stations, user equipment, spectrum management apparatus, etc.), and the implementation form of the transceiver is not specifically limited here.

When there are already multiple second priority level secondary users using the same frequency band in the licensed area where the first priority level secondary user is located, the interferences the first priority level secondary user is subjected to may be close to its interference threshold. At this time, if a new second priority level secondary user (hereinafter also referred to as a requester) requests to use the spectrum resources, it may not be able to access in. According to the electronic device 100 of this embodiment, a coordination mechanism is provided to enable the second priority level secondary users who have already accessed in to perform coordination to provide corresponding interference margins, so that the requester can successfully access in the spectrum resources, thereby improving the efficiency of dynamic spectrum sharing.

In this embodiment, a block chain including the second priority level secondary users is built and a coordination operation is executed using the block chain to achieve decentralized spectrum management. The block chain may also include the first priority level secondary user, a spectrum management apparatus, etc., which are not limiting. Referring to the example shown in FIG. 2, multiple GAA users and the requesting GAA users constitute a block chain.

When another second priority level secondary user as a requester for spectrum resources have spectrum requirements, it can send a spectrum coordination request to the second priority level secondary users who are utilizing the spectrum resources (hereinafter also referred to as existing second priority level secondary users) through the block chain. The spectrum coordination request is confirmed by the spectrum management apparatus and indicates that the requester requests the existing second priority level secondary users to perform coordination to provide the interference margin.

Specifically, for example, the requester can send a spectrum query request to the spectrum management apparatus, and the spectrum management apparatus can return available frequency bands or coordinated available frequency bands to the requester, wherein the available frequency bands are idle spectrum resources that are available in the current system without the need of coordination, and can be directly accessed in by the requester. The coordinated available frequency band is a spectrum range that can provide a certain interference margin for access in by the requester through reducing the emission power by the existing second priority level secondary users, for example, it can be regularly notified to the spectrum management apparatus by the first priority level secondary users. In the latter case, the requester sends a message of accepting coordination to the spectrum management apparatus, and receives a spectrum coordination request confirmed by the spectrum management apparatus, from the spectrum management apparatus.

For example, the spectrum coordination request may include signature information of the spectrum management apparatus for use by the existing second priority level secondary users to confirm the authenticity of the spectrum coordination request. In addition, the spectrum coordination request may also include one or more of the requested frequency band, emission power, and geographic location of the requester.

The requester sends the spectrum coordination request to existing second priority level secondary users, for example, by broadcasting on the block chain.

In addition, the spectrum management apparatus can also notify the first priority level secondary user nearest to the requester or the first priority level secondary user that may be most interfered with that a new second priority level secondary user may be added to its frequency band. For example, in the CBRS system, the SAS serving as the spectrum management apparatus performs the notification through a heartbeat response.

After the acquisition unit 101 acquires the spectrum coordination request, the execution unit 102 executes the first smart contract on the block chain to determine the content of the coordination to be performed, that is, how to perform the coordination to provide the interference margin for the requester. Here, all the existing second priority level secondary users execute the first smart contract. Through the execution of the first smart contract, the second priority level secondary users who are willing to participate in the coordination and the emission power that can be reduced are collected, and the second priority level secondary users that will finally participate in this coordination and the specific implementation of the coordination are determined according to, for example, a predetermined rule.

For example, the content of the coordination may include one or more of an identifier, an interference margin to be provided, emission power, and a geographical location of the second priority level secondary user participating in the coordination.

After executing the first smart contract, the requester also obtains the content of coordination through the block chain. In the first example, the requester sends a grant request containing the content of coordination to the spectrum management apparatus. The spectrum management apparatus determines the feasibility of the grant request based on the data it grasps. If the content of coordination is feasible, it returns a grant success response to the requester, otherwise it sends a grant failure response to the requester.

In the case of grant success, the requester can notify the existing second priority level secondary users or the existing second priority level secondary users participating in the coordination of the grant success response through the block chain. The execution unit 102 of the electronic device 100 is configured to execute the second smart contract in response to the grant success response, so that the second priority level secondary users participating in the coordination reduce the emission power according to the content of the coordination, that is, provide the requester with the interference margin as expected. In this way, the requester can successfully access in the frequency band using the interference margin provided by the coordination.

In addition, the execution unit 102 is further configured to execute the second smart contract to calculate the coordination factor value of the second priority level secondary user participating in the coordination, to evaluate the contribution of the corresponding second priority level secondary user to the interference margin.

Exemplarily, a specific method for calculating the coordination factor value ηi of the i-th second priority level secondary user will be described below. However, it should be understood that the calculation method of the coordination factor value is not limited thereto, a method may be applied as long as the contribution of the second priority level secondary user to the interference margin can be evaluated.

$${η}_{i} = {M}_{i} ( 1 - {e}^{- γ {F}_{i}} ) \qquad ( 1 )$$

Among them, ηᵢ is an increasing function of Mᵢ and Fᵢ. Mᵢ represents the interference margin contribution degree of the i-th second priority level secondary user in this coordination process, Fᵢ represents the coordination activity degree of the i-th second priority level secondary user in a certain time period, such as a time period of a predetermined length or a time period from a specific moment to the current time period, and γ represents the activity influence coefficient.

For example, Mᵢ and Fᵢ can be calculated as follows, respectively:

$${M}_{i} = \frac{{P}_{reduce}}{{P}_{current} - {P}_{min}} \qquad ( 2 )$$

Wherein, P_{reduce} is the emission power reduced by the second priority level secondary user in this coordination process, P_{current} is the current emission power of the second priority level secondary user, and Pₘᵢₙ is the minimum power required by the second priority level secondary user to ensure normal operation.

$${F}_{i} = {ω}_{1} * {F}_{i 1} + {ω}_{2} * {F}_{i 2} \qquad ( 3 )$$

Among them, Fᵢ₁ is the number of times the second priority level secondary user participates in coordination within [T₀, T_{current}], Fᵢ₂ is the number of times the second priority level secondary user participates in coordination within [2T₀−T_{current}, T₀], T₀ is a certain moment, and T_{current} is the current moment; ω₁, and ω₂ correspond to different weight coefficients, satisfying ω₁+ω₂=1, ω₁>ω₂.

The coordination factor value reflects the activity degree of the corresponding second priority level secondary user in participating in the coordination within a certain period of time and the contributed interference margin, and can therefore be used as a factor of the comprehensive contribution degree of the second priority level secondary user. The comprehensive contribution degree will be used to determine the accounting node in the accounting process to be described later.

In addition, when executing the first smart contract, the execution unit 102 may determine the second priority level secondary users participating in the coordination according to the trust values of the second priority level secondary users who agree to participate in the coordination. For example, the second priority level secondary users may be ranked according to their trust values, and one or more second priority level secondary users ranked in front may be determined to perform the coordination.

The trust value is determined based on the activity degree of the corresponding second priority level secondary user in participating in the coordination and/or the occurrence frequency of violation behaviors. The higher the activity degree of the second priority level secondary user in participating in coordination is and the lower the occurrence frequency of violation behaviors is, the higher the trust value is.

The violation behaviors mentioned here include, for example, the following behaviors: the second priority level secondary user confirmed to participate in the coordination does not reduce the emission power according to the determined content of coordination, or the second priority level secondary user as the requester does not access in the spectrum resources according to the requested emission power, etc.

The trust value of each second priority level secondary user changes with the user's behavior. Therefore, for example, the execution unit 102 can also be configured to execute a third smart contract on the block chain to update the trust value.

By way of example, a specific method for updating the trust value is given below, which should be understood to be non-limiting. As shown in the following equation (4), tᵢ(n) is the trust value of the i-th second priority level secondary user upon performing n times of coordination.

$${t}_{i} ( n ) = \{ \begin{matrix}α \cdot {t}_{i} ( n - 1 ) & if not participate in the coordination \\ {t}_{i} ( n - 1 ) + Δ {t}_{i} & if there is no violation behavior \\ β \cdot {t}_{i} ( n - 1 ) & if there is a violation behavior\end{matrix} \qquad ( 4 )$$

Among them, the initial trust value of the second priority level secondary user is tᵢ(0)=t₀, α is the attenuation coefficient. When the second priority level secondary user does not participate in the coordination, the trust value will be attenuated a little to promote the second priority level secondary user to actively participate in the coordination. β is the attenuation coefficient of the trust value of the violating user. When the second priority level secondary user participates in the coordination but performs violation behaviors, the trust value will suffer a large loss. Δtᵢ is the trust value increment when successfully participating in the coordination and there being no violation behavior. Among them, β and α can be values less than 1 and greater than 0, and β<α.

For example, whether the second priority level secondary user has violated the rules can be determined by the spectrum management apparatus. Specifically, when there is a second priority level secondary user who has violated the rules, there may be a first priority level secondary user which is subjected to interferences beyond its interference threshold. The first priority level secondary user will inform the spectrum management apparatus of this situation. The spectrum management apparatus determines the second priority level secondary users who have implemented the violation behavior and produced harmful interferences to the first priority level secondary user, based on the operating parameters of the second priority level secondary users currently accessed in, such as the currently used frequency band, emission power, and geographic locations, and sends a list of them to the second priority level secondary users in the block chain. It should be understood that although an example of the spectrum management apparatus determining a violation behavior in response to a report from a first priority level secondary user is given here, which is not limiting. For example, alternatively/additionally, the spectrum management apparatus may also regularly check whether a violation behavior has occurred.

Accordingly, the acquisition unit 101 may receive, from the spectrum management apparatus, a list of second priority level secondary users that implement the violation behaviors, and the execution unit 102 executes the third smart contract in response to the reception to update the trust value.

As mentioned above, when executing the first smart contract to select the second priority level secondary users to participate in the coordination, the execution unit 102 preferentially selects the second priority level secondary users with high trust values, which can increase the probability of successful coordination and improve the robustness of the system

The second example is described below, and the difference between the second example and the first example lies in that when coordination is performed, the influence on the first priority secondary users other than the first priority secondary user nearest to the requester (or the first priority secondary user that may be most interfered with) in the same spectrum licensed region is also considered. That is, the second example also performs coordination among multiple first priority level secondary users, thereby further improving the coordination process and enhancing the performance of the dynamic spectrum sharing system.

In the second example, the requester also sends the content of coordination determined by the execution of the first smart contract to the nearest first priority level secondary user, which forwards it to other first priority level secondary users using spectrum resources. The nearest first priority level secondary user receives, from the affected first priority level secondary user, information on whether to agree to increase its own interference threshold and forwards it to the requester. The requester includes the information that the affected first priority level secondary user agrees to increase its own threshold in the grant request and provides it to the spectrum management apparatus.

Specifically, another first priority level secondary user who receives the content of coordination determines whether the aggregate interferences generated by the requester's joining exceeds its own interference threshold, that is, whether it is affected, based on the content of coordination. If the aggregate interferences exceed its own interference threshold, the another first priority level secondary user can choose to increase its own interference threshold for coordination to allow the requester to access in, and at this time, information on agreeing to increase its own threshold is returned to the nearest first priority level secondary user mentioned above. The information may also include information on the amount of the threshold agreed to be increased. On the other hand, if the another affected first priority level secondary user does not agree to increase its own threshold, it may also return information indicating disagreement with increasing its own threshold or not return information.

In order to encourage the affected first priority level secondary users to participate in the coordination, some incentive measures may be taken. For example, if the affected first priority level secondary user agrees to participate in the coordination, it is given a mark indicating that the compensation with respect to the corresponding first priority level secondary user will be added in the next coordination process. And, after the affected first priority level secondary user receives the compensation, the mark is cancelled.

In this example, the grant request sent to the spectrum management apparatus includes the content of coordination of the existing second priority level secondary users and the information that the affected first priority level secondary users agree to increase their own interference thresholds. The spectrum management apparatus determines whether the grant request including both is feasible based on the data it grasps. The subsequent process is the same as that in the first example. When the grant request is determined to be feasible, the spectrum management apparatus sends a grant success response to the requester. In addition, the grant success response is provided to the existing second priority level secondary users through the block chain, so that the second priority level secondary users participating in the coordination reduce the emission power and the requester is allowed to access in. In addition, the spectrum management apparatus can also notify the affected first priority level secondary users to allow them to increase their own interference thresholds.

In the above description, the second priority level secondary user corresponding to the electronic device 100 is taken as an example of an existing second priority level secondary user, which is not limiting, and the electronic device 100 may also correspond to a second priority level secondary user as a requester. At this time, the electronic device 100 may perform the operations of the requester in the above description, such as requesting for spectrum resources and requesting for coordination, and after successfully accessing in the spectrum resources, it may also perform the above mentioned various operations where the existing second priority level secondary user participates in coordination.

For example, in the case where the electronic device 100 corresponds to the requester, the electronic device 100 may include a processing circuit configured to send a spectrum coordination request confirmed by a spectrum management apparatus to existing second priority level secondary users based on a block chain; and include the content of the coordination determined by the execution of the first smart contract in a grant request to be sent to the spectrum management apparatus. The processing circuit may also receive a grant success response to the grant request from the spectrum management apparatus, and send it to the existing second priority level secondary users through the block chain. In addition, as mentioned above, the grant request may also include information that the affected first priority level secondary user agrees to increase its own threshold. The relevant details have been given in the previous text and will not be repeated here.

In summary, the electronic device 100 according to this embodiment provides the corresponding interference margin by causing the second priority level secondary users who are using the spectrum resources to perform coordination, so that the new second priority level secondary users can successfully access in the spectrum resources, thereby improving the efficiency of dynamic spectrum sharing. In addition, decentralized spectrum management is achieved by forming a block chain of second priority level secondary users and performing coordination operations based on the block chain. In addition, the coordination process can be further improved through interference coordination between multiple first priority level secondary users, thereby improving the performance of the dynamic spectrum sharing system.

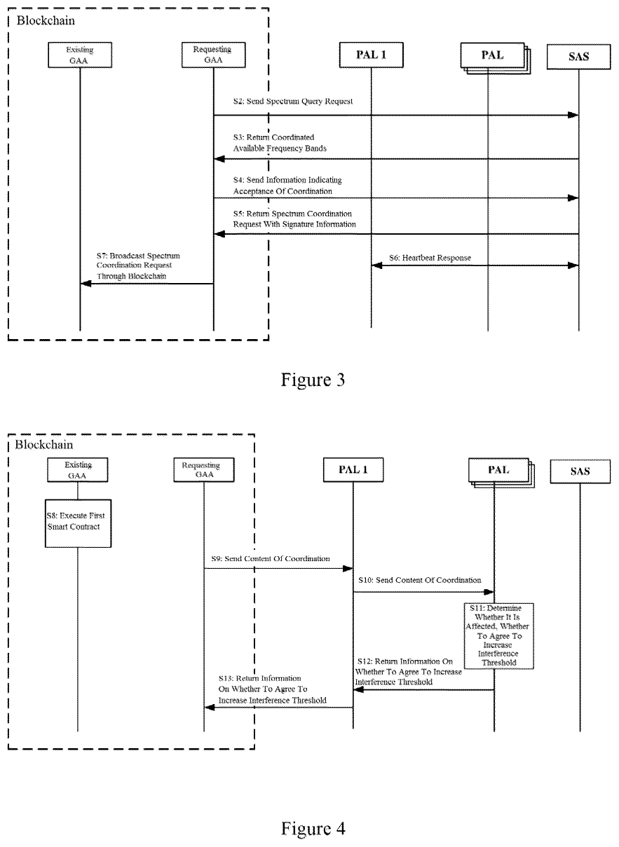

For ease of understanding, an example of the information flow of the above coordination process is given below with reference to FIGS. 3 to 6, taking the CBRS system scenario shown in FIG. 2 as an example. It should be understood that this is not limiting.

FIG. 3 shows an information flow chart of the process that a requesting GAA requests for coordination. Among them, first in step S1 (not shown), a block chain including multiple GAA nodes is built in the licensed area, and the block chain includes an existing GAA (GAA that has accessed in) and a requesting GAA. In step S2, the requesting GAA sends a spectrum query request to the SAS. In step S3, the SAS can return available frequency bands and/or coordinated available frequency bands to the requesting GAA, and FIG. 3 shows the situation of returning coordinated available frequency bands. The requesting GAA can send information indicating acceptance of coordination to the SAS in step S4. In step S5, the SAS returns a spectrum coordination request with signature information to the requesting GAA, and the signature information indicates that the spectrum coordination request has been confirmed to be true by the SAS, and the spectrum coordination request also includes the requested frequency band, emission power, geographic location and other information of the requesting GAA. Specifically, for example, the SAS has a certificate, and the GAA users in the dynamic spectrum sharing system all have the public key of the asymmetric key pair of the SAS. The SAS signs the message with the private key and returns the information with the signature to the requesting GAA. After receiving the signature information, the existing GAA user uses the public key provided by the SAS to decrypt it to determine the authenticity of the received spectrum coordination request.

At the same time as step S5, in step S6, the SAS also notifies the nearest PAL, namely PALI user, through a heartbeat response that a new GAA user may be added to its frequency band. In step S7, the requesting GAA provides a spectrum coordination request to an existing GAA through block chain broadcast to request it to provide interference margin.

FIG. 4 shows an information flow chart of the coordination process of the existing GAA and PAL. In step S8, the existing GAA that receives the spectrum coordination request executes the first smart contract on the block chain, collects the GAA users who agree to participate in this coordination and the emission power that can be reduced, and determines, according to the trust value of the GAA users, the identifier of the GAA users who finally participate in the coordination and the specific coordination implementation, such as the interference margin, emission power, geographical location or the like that are required to be provided, which are collectively referred to as the content of coordination. After step S8, the requesting GAA also obtains the content of coordination, and sends the content of coordination to PAL 1 in step S9, and PAL 1 forwards it to other PALs in step S10. In step S11, another PAL determines whether the joining of the requesting GAA will have an impact on itself, for example, whether the aggregate interferences generated by the joining of the requesting GAA will exceed its own interference threshold. If the joining of the requesting GAA will cause the aggregate interferences to exceed its own interference threshold, it is also determined whether to agree to coordinate the access of the requesting GAA by increasing its own interference threshold. In step S12, the affected PAL sends information on whether it agrees to increase its own interference threshold to PAL 1. In this example, it is assumed that the affected PAL agrees to increase its own interference threshold. In step S13, PAL 1 forwards the information to the requesting GAA.

FIG. 5 shows an information flow chart of the process that the requesting GAA is granted to access in the spectrum. In step S14, the requesting GAA sends a grant request to the SAS, and the grant request includes the content of GAA coordination and the information that the affected PAL agrees to increase its own interference threshold. In step S15, the SAS determines the feasibility of the coordination in the grant request through the grasped data, and sends a grant success response or a grant failure response to the requesting GAA in step S16 based on the result of the determination. In this example, it is assumed that coordination is feasible, so the SAS sends a grant success response to the requesting GAA. Upon receiving the grant success response, the requesting GAA notifies the existing GAA, so as to execute the second smart contract on the block chain in step S17. Through the execution of the second smart contract, the GAA participating in the coordination reduces the emission power according to the content of the coordination to provide the interference margin, so that the requesting GAA successfully accesses in. The requesting GAA needs to send a heartbeat request to the SAS regularly during operation (step S18), and the SAS returns a heartbeat response to the requesting GAA (step S19). In addition, when the second smart contract is executed in step S17, the coordination factor value of the GAA user is also calculated to evaluate the contribution of the corresponding GAA user to the interference margin. The example of calculating the coordination factor value is described above and will not be repeated here.

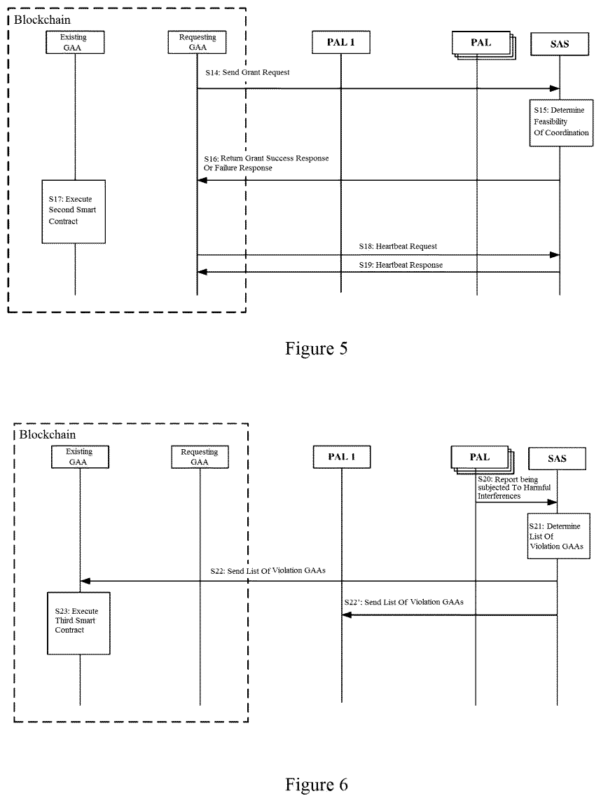

FIG. 6 shows an information flow chart for updating of the trust value. Due to the existence of the violation behaviors, such as the GAA users participating in the coordination not reducing the emission power as expected or the requesting GAA not accessing in according to the expected emission power, it may lead to one or more PAL users being subjected to interferences that exceed their own interference thresholds. In step S20, these PAL users report to the SAS that they have been subjected to harmful interferences. In step S21, the SAS determines the violation GAA that causes harmful interferences to the above PAL based on the operating parameters of the currently operating GAA users, such as the current frequency band, emission power, and geographical location of the GAA users. In step S21, the SAS sends the list of violation GAAs to the GAA users on the block chain. In addition, optionally, step S21′ may also be included: sending the list of violation GAAs to PAL 1. Upon receiving the list of violation GAAs, a third smart contract is executed on the block chain in step S22 to update the trust value. The example of the calculation of the trust value is described above and will not be repeated here.

### Second Embodiment

In this embodiment, a technology for accelerating the consensus process of the block chain is provided. For example, the execution unit 102 is further configured to determine, based on the comprehensive contribution degrees of respective second priority level secondary users in the coordination process, a second priority level secondary user as the accounting node on the block chain, and the accounting node generates a block. For example, the second priority level secondary user with a high comprehensive sharing degree is preferentially selected as the accounting node.

As an example, the comprehensive contribution degree may include a coordination factor value and a trust value. As described above, the coordination factor value indicates the contribution of the corresponding second priority level secondary user to the interference margin, and the trust value indicates the activity degree of the corresponding second priority level secondary user in participating in the coordination and/or the occurrence frequency of violation behaviors. A second priority level secondary user with a higher coordination factor value and a higher trust value is considered to have a higher comprehensive contribution degree.

For example, the execution unit 102 may divide respective second priority level secondary users into a first level and a second level according to the comprehensive contribution degrees, and preferentially determine the second priority level secondary user in the first level as the accounting node, wherein the comprehensive contribution degree of the second priority level secondary users in the first level is higher than the comprehensive contribution degree of the second priority level secondary users in the second level. In this way, the second priority level secondary user with high comprehensive contribution degree can be preferentially selected as the accounting node under the premise of ensuring fairness.

The determined accounting node, for example, packages the content of executed coordination, updated coordination factor value and trust value within a certain period of time to generate a block. In other words, the block may include the specific content of spectrum coordination and the comprehensive contribution degree of each second priority level secondary user in the coordination process. The specific content of the spectrum coordination includes: information on the interference margin provided by the second priority level secondary user participating in the coordination by reducing its own emission power, the time point when the coordination process ends, and so on.

After generating a block, the accounting node broadcasts the block on the block chain. Other second priority level secondary users on the block chain verify the block and store the data in the block locally after the verification is successful.

According to the electronic device 100 of this embodiment, by determining the accounting node according to the comprehensive contribution degrees, the consensus process of the block chain is accelerated, the latency of the block chain is reduced, and the efficiency of the dynamic spectrum sharing system is improved.

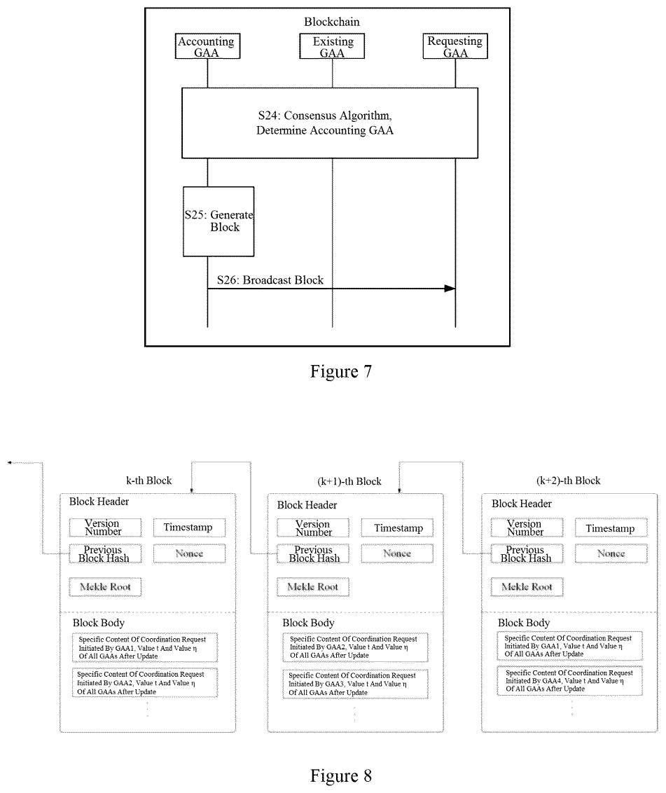

For ease of understanding, an example of the information flow of the above consensus process is given below with reference to FIG. 7, taking the CBRS system scenario shown in FIG. 2 as an example. It should be understood that this is not limiting.

Note that for the sake of clarity, the accounting GAA serving as the accounting node is shown separately in FIG. 7, and the accounting GAA can be one of the existing GAA and the requesting GAA. In step S24, the above-mentioned consensus algorithm is executed, that is, the accounting GAA is determined as the accounting node based on the comprehensive contribution degrees. For example, the accounting GAA can be a random GAA among the GAAs with a comprehensive sharing degree at the first level. In step S25, the accounting GAA generates a block based on the content of the coordination performed within a certain period of time, the updated coordination factor value and the trust value. In step S26, the accounting GAA broadcasts the generated block on the block chain so that other GAAs can obtain and verify the new block.

FIG. 8 shows an example of a block generated by the accounting node. Each block includes a block header and a block body. The block header includes a version number, a timestamp, a previous block Hash, a Nonce, and a Mekle Root. For example, the (k+1)-th block is linked to the previous block through the previous block Hash in the block header. The block body includes the specific content of the coordination request initiated by the requesting GAA within a certain period of time, the coordination factor value (η) and the trust value (t) of all GAAs after the update. It should be understood that FIG. 8 is only an example of a block chain and is not limiting.

### Third Embodiment

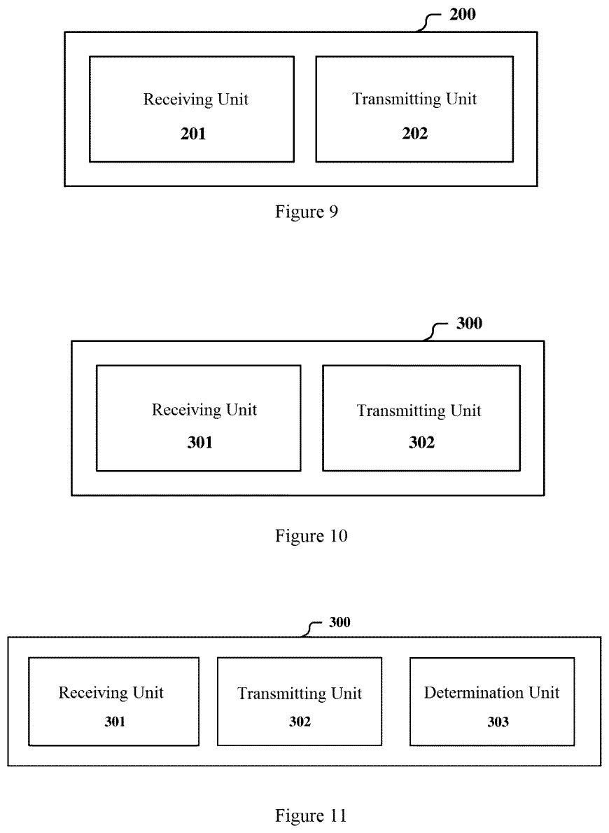

FIG. 9 shows a functional module block diagram of an electronic device 200 for a first priority level secondary user according to another embodiment of the present application. As shown in FIG. 9, the electronic device 200 includes: a receiving unit 201, configured to receive, from a second priority level secondary user who is a requester for spectrum resources, the content of coordination to be performed by other second priority level secondary users participating in the coordination, wherein the requester requests other second priority level secondary users who are utilizing the spectrum resources to perform coordination to provide an interference margin for the requester; and a transmitting unit 202, configured to forward the content of coordination to another first priority level secondary user utilizing the spectrum resources, wherein the receiving unit 201 further receives, from the affected first priority level secondary user, information as to whether to agree to increase its own interference threshold, and the transmitting unit 202 transmits a response to the requester based on the information.

The receiving unit 201 and the transmitting unit 202 may be implemented by one or more processing circuits, which may be implemented as a chip or a processor, for example. In addition, it should be understood that the various functional units in the electronic device shown in FIG. 9 are only logical modules divided according to the specific functions implemented by them, and are not used to limit the specific embodiment.

The electronic device 200 can be set on the first priority level secondary user side, for example, on its base station side or communicatively connected to the base station. Here, it should also be pointed out that the electronic device 200 can be implemented at the chip level, or it can also be implemented at the device level. For example, the electronic device 200 can work as the base station itself, and can also include external devices such as memory, transceiver (not shown in the figure), etc. The memory can be used to store programs and related data information required by the electronic device to implement various functions. The transceiver may include one or more communication interfaces to support communication with different devices (for example, other base stations, user equipment, spectrum management apparatus, etc.), and the implementation form of the transceiver is not specifically limited here.

In this embodiment, the first priority level secondary user corresponding to the electronic device 200 is, for example, the first priority level secondary user nearest to the requester or the first priority level secondary user that may be most interfered with. In the CBRS system scenario shown in FIG. 2, the first priority level secondary user corresponding to the electronic device 200 is, for example, PAL 1.

The content of the coordination may include, for example, one or more of an identifier, an interference margin to be provided, emission power, and a geographical location of the second priority level secondary user participating in the coordination.

Another first priority level secondary user, for example, determines whether the aggregate interferences generated by the joining of the requester exceed its own interference threshold based on the content of coordination. If so, the joining of the requester will have an impact on the corresponding first priority level secondary user. At this time, the first priority level secondary user is to decide whether to increase its own interference threshold to allow the requester to access in, and notify the first priority level secondary user corresponding to the electronic device 200 of the decision result.

In order to encourage the affected first priority level secondary users to participate in the coordination, some incentive measures may be taken. For example, if the affected first priority level secondary user agrees to participate in the coordination, it is given a mark indicating that the compensation with respect to the corresponding first priority level secondary user will be added in the next coordination process. And, after the affected first priority level secondary user receives the compensation, the mark is cancelled.

In the example of the CBRS system scenario, an example of the relevant information flow can be referred to, for example, FIG. 4. The relevant details have been given in the first embodiment and will not be repeated here.

In summary, the electronic device 100 according to this embodiment improves the performance of dynamic spectrum sharing by performing interference coordination among multiple first priority level secondary users.

### Fourth Embodiment

FIG. 10 shows a functional module block diagram of an electronic device 300 for a spectrum management apparatus according to another embodiment of the present application. As shown in FIG. 10, the electronic device 300 includes: a receiving unit 301, configured to receive, from a second priority level secondary user who is a requester for spectrum resources, information indicating that the requester accepts spectrum coordination, through which other second priority level secondary users who are utilizing the spectrum resources perform coordination to provide an interference margin for the requester; and a transmitting unit 302, configured to transmit a spectrum coordination request confirmed by the spectrum management apparatus to the requester.

The receiving unit 301 and the transmitting unit 302 may be implemented by one or more processing circuits, which may be implemented as a chip or a processor, for example. In addition, it should be understood that the various functional units in the electronic device shown in FIG. 10 are only logical modules divided according to the specific functions implemented by them, and are not used to limit the specific implementation.

The electronic device 300 may be arranged on the side of the spectrum management apparatus or may be communicatively connected to the spectrum management apparatus. The spectrum management apparatus may be located on the side of the base station, for example, implemented by a macro base station or a small base station, or located in the core network, for example, implemented by an Evolved Packet Core (EPC) or a 5G Core Network (5G Core, 5GC) under the LTE protocol, or may be independently implemented by a third-party entity independent of the wireless network and connected to the wireless network through the network management unit (Operation and Management, OAM) of the wireless network.

Here, it should also be pointed out that the electronic device 300 can be implemented at the chip level, or it can also be implemented at the device level. For example, the electronic device 300 can work as the spectrum management apparatus itself, and can also include external devices such as memory, transceiver (not shown in the figure), etc. The memory can be used to store programs and related data information required by the electronic device to implement various functions. The transceiver may include one or more communication interfaces to support communication with different devices (for example, other spectrum management apparatus, base stations, etc.), and the implementation form of the transceiver is not specifically limited here.

As mentioned above, when the second priority level secondary user as a requester requests to use the spectrum resources, there may be no idle spectrum resources for the requester to directly access in, but only coordinated available resources. The coordinated available resources are spectrum resources that are already being used by multiple second priority level secondary users among the spectrum resources of the current first priority level secondary user, and can provide a certain interference margin for the requester to access in by reducing the emission power of these second priority level secondary users (that is, existing second priority level secondary users).

In this case, the spectrum management apparatus receives information from the requester that the requester accepts spectrum coordination, and sends a confirmed spectrum coordination request to the requester, so that the requester can use the spectrum coordination request to request the existing second priority level secondary users to participate in the coordination.

For example, the spectrum coordination request includes signature information of the spectrum management apparatus for existing second priority level secondary users to confirm the authenticity of the spectrum coordination request. In addition, the spectrum coordination request may further include one or more of the requester's requested frequency band, emission power, and geographic location. In the example of the CBRS system scenario, an example of the relevant information flow can be referenced to FIG. 3, for example. The relevant details have been given in the first embodiment and will not be repeated here.

As described in the first embodiment, the second priority level secondary users constitute a block chain, and by executing the first smart contract on the block chain, the content of the coordination to be performed by the second priority level secondary users can be determined. In addition, the requester can also send the content of coordination to the nearest first priority level secondary user, and the nearest first priority level secondary user forwards it to other first priority level secondary users. Other first priority level secondary users determine whether the aggregate interference generated by the joining of the requester will exceed their own interference threshold based on the content of coordination, and if it exceeds, determine whether to agree to increase their own interference threshold to allow the requester to access in. In other words, interference coordination can also be performed among multiple first priority level secondary users.

The requester generates a grant request based on the content of coordination and whether the affected first priority level secondary user agrees to increase its own interference threshold, and sends it to the spectrum management apparatus. The receiving unit 301 is further configured to receive the grant request from the requester, which includes the content of the coordination to be performed and the information that the affected first priority level secondary user agrees to increase its own interference threshold. Of course, the grant request can also only include the content of the coordination to be performed. For example, the content of coordination includes one or more of the identifier, the interference margin to be provided, the emission power and the geographical location of the second priority level secondary user participating in the coordination.

FIG. 11 shows a functional module block diagram of another example of an electronic device 300. Compared with FIG. 10, the electronic device 300 of this example further includes a determination unit 303, which is configured to determine the feasibility of the grant request. The transmitting unit 302 is configured to send a grant success response to the requester if the grant request is feasible, and to send a grant failure response to the requester if the grant request is not feasible. In addition, the determination unit 303 can also send a notification to the first priority level secondary user who is affected but agrees to increase its own interference threshold to allow it to increase its own interference threshold. In order to encourage the participation of the first priority level secondary user in spectrum coordination, some incentive measures can also be taken. For example, the determination unit 303 can mark the first priority level secondary user who is affected by the joining of the requester but agrees to increase its own interference threshold. The mark indicates that the compensation with respect to the corresponding first priority level secondary user will be added in the next coordination process. In addition, the determination unit 303 can be configured to cancel its mark after the marked first priority level secondary user receives the compensation.

When the requester receives a grant success response, it means that the spectrum management apparatus allows coordination in accordance with the coordination manner in the grant request. The second smart contract is executed on the block chain so that the second priority level secondary users participating in the coordination reduce the emission power according to the content of coordination to increase the interference margin. At the same time, the affected first priority level secondary users (if any) increase their own interference threshold to allow the requester to access in. The second smart contract can also calculate the coordination factor value of the second priority level secondary user, which can affect the probability of the second priority level secondary user being determined as an accounting node during the block chain consensus process.

In the example of the CBRS system scenario, an example of the relevant information flow can be referred to, for example, FIG. 5. The relevant details have been given in the first embodiment and will not be repeated here.

After the requester accesses in the spectrum resources through the above coordination process, there may be violation behaviors, such as the second priority level secondary user confirmed to participate in the coordination does not reduce the emission power according to the determined content of coordination, or the second priority level secondary user as the requester does not access in the spectrum resources according to the requested emission power. These violation behaviors may cause the first priority level secondary user to be subject to harmful interferences, that is, the subjected interferences exceed its own interference threshold. The receiving unit 301 can further be configured to receive notifications from these first priority level secondary users, and the determination unit 303 is configured to determine the second priority level secondary users who have committed violation behaviors and caused harmful interferences to the first priority level secondary users, based on the operating parameters of the currently operating second priority level secondary users.

The transmitting unit 302 may be configured to send the identifier of the second priority level secondary user who has committed the violation behaviors to the first priority level secondary user whose subjected interferences exceed its own interference threshold and/or the block chain composed of the second priority level secondary users. As described in the first embodiment, a third smart contract may be executed on the block chain to update the trust value of each second priority level secondary user. The trust value may affect the probability that the second priority level secondary user is finally determined as a user participating in the coordination when attempting to participate in the coordination and is determined as an accounting node in the block chain consensus process.

In the example of the CBRS system scenario, an example of the relevant information flow can be referred to, for example, FIG. 6. The relevant details have been given in the first embodiment and will not be repeated here.

In summary, the electronic device 300 according to this embodiment provides the corresponding interference margin by allowing the second priority level secondary users who are using the spectrum resources to perform coordination, so that the new second priority level secondary user can successfully access in the spectrum resources, thereby improving the efficiency of dynamic spectrum sharing. In addition, the coordination process can be further improved through interference coordination among multiple first priority level secondary users, thereby improving the performance of the dynamic spectrum sharing system.

### Fifth Embodiment

In the process of describing various electronic devices in the above embodiments, it is obvious that some processes or methods are also disclosed. Below, an overview of these methods is given without repeating some of the details discussed above, but it should be noted that although these methods are disclosed in the process of describing electronic devices, these methods do not necessarily use the components described or are not necessarily performed by those components. For example, the implementation of the electronic device can be partially or completely implemented using hardware and/or firmware, and the various methods discussed below can be completely implemented by a computer executable program, although these methods can also use the hardware and/or firmware of the aforementioned electronic device.

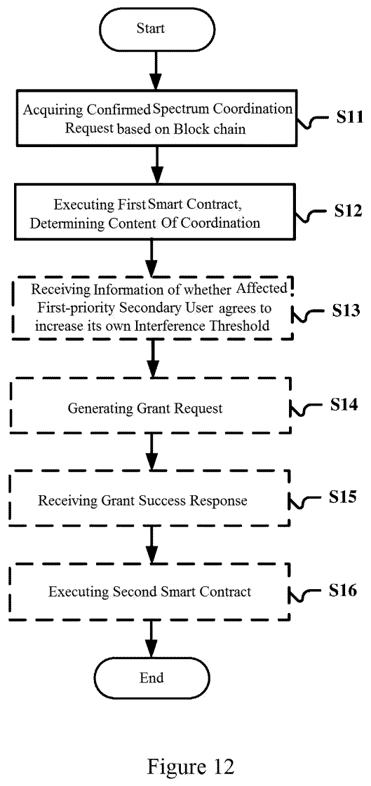

FIG. 12 shows a flow chart of a method for a second priority level secondary user according to an embodiment of the present application. As shown in FIG. 12, the method includes: acquiring, based on a block chain, a spectrum coordination request confirmed by a spectrum management apparatus from another second priority level secondary user who is a requester for the spectrum resources (S11), wherein the block chain at least includes each second priority level secondary user who is utilizing or requesting to utilize the spectrum resources as a node, and the spectrum coordination request indicates that the requester requests the second priority level secondary users who are utilizing the spectrum resources to perform coordination to provide an interference margin for the requester; and executing a first smart contract on the block chain to determine the content of the coordination to be performed (S12). The method can be executed on the second priority level secondary user side, for example.

For example, the content of the coordination may include one or more of an identifier, an interference margin to be provided, emission power, and a geographical location of the second priority level secondary user participating in the coordination.

The spectrum coordination request may include signature information of the spectrum management apparatus, and the spectrum coordination request may also include one or more of a requested frequency band, emission power, and a geographical location of the requester.

In one example, as shown in the dotted line block in FIG. 12, the method further includes the following steps: the requester sending a grant request containing at least the content of coordination to the spectrum management apparatus (S14); receiving a grant success response from the spectrum management apparatus (S15); and in response to the grant success response, executing a second smart contract on the block chain so that the second priority level secondary users participating in the coordination reduce the emission power according to the content of coordination (S16). In addition, when executing the second smart contract, the coordination factor value of the second priority level secondary users participating in the coordination can also be calculated to evaluate the contribution of the corresponding second priority level secondary users to the interference margin.

In one example, as shown in another dotted line block in FIG. 12, the method further includes the following step: receiving information that the affected first priority level secondary user agrees to increase its own interference threshold (S13). Specifically, for example, the requester sends the content of coordination to the nearest first priority level secondary user, which forwards it to other first priority level secondary users using spectrum resources, and the nearest first priority level secondary user receives, from the affected first priority level secondary user, information of whether to agree to increase its own interference threshold and forwards it to the requester. In this case, the generated grant request also includes information that the affected first priority level secondary user agrees to increase its own interference threshold.

Exemplarily, step S12 includes: executing the first smart contract to determine the second priority level secondary users participating in the coordination according to the trust values of the second priority level secondary users who agree to participate in the coordination. The trust value can be determined based on the activity degree of the corresponding second priority level secondary users in participating in the coordination and/or the occurrence frequency of violation behaviors.

Although not shown in the figure, the above method may further include the following steps: executing a third smart contract on the block chain to update the trust value. For example, a list of second priority level secondary users who have committed violation behaviors may be received from the spectrum management apparatus, and the third smart contract may be executed in response to the reception.

In addition, although not shown in the figure, the above method may also include: determining, based on the comprehensive contribution degree of each second priority level secondary user in the coordination process, a second priority level secondary user as an accounting node on the block chain, and the accounting node generating a block. For example, the block includes the specific content of spectrum coordination and the comprehensive contribution degree of each second priority level secondary user in the coordination process. The comprehensive contribution degree, for example, includes a coordination factor value and a trust value, the coordination factor value indicates the contribution of the corresponding second priority level secondary user to the interference margin, and the trust value indicates the activity degree of the corresponding second priority level secondary user in participating in the coordination and/or the occurrence frequency of violation behaviors.

The specific content of the spectrum coordination includes, for example: information on the interference margin provided by the second priority level secondary user participating in the coordination by reducing its own emission power, and the time point when the coordination process ends.

As an example, the second priority level secondary users can be divided into the first level and the second level according to their comprehensive contribution degrees, and the second priority level secondary users in the first level can be preferentially determined as the accounting node, wherein the comprehensive contribution degree of the second priority level secondary user in the first level is higher than the comprehensive contribution degree of the second priority level secondary user in the second level.

Similarly, in this embodiment, the dynamic spectrum sharing system may be a CBRS system, the primary user is an incumbent, the first priority level secondary user is a PAL user, and the second priority level secondary user is a GAA user.

The above method corresponds to the electronic device 100 in the first embodiment and the second embodiment. The specific details can be referred to the first embodiment and the second embodiment, which will not be repeated here.

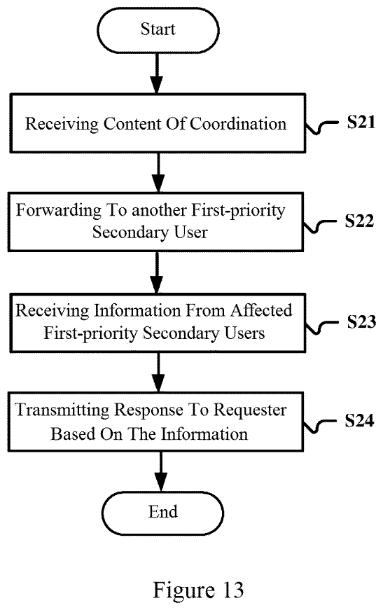

FIG. 13 shows a flow chart of a method for a first priority level secondary user according to an embodiment of the present application. As shown in FIG. 13, the method includes: receiving, from a second priority level secondary user who is a requester for spectrum resources, the content of coordination to be performed by other second priority level secondary users participating in the coordination (S21), wherein the requester requests other second priority level secondary users who are utilizing the spectrum resources to perform coordination to provide an interference margin for the requester; forwarding the content of the coordination to other first priority level secondary users utilizing the spectrum resources (S22); receiving, from affected another first priority level secondary user whether it agrees to increase its own interference threshold (S23); and sending a response to the requester based on the information (S24). The method can be performed, for example, on the first priority level secondary user side.

For example, the content of coordination includes one or more of an identifier, an interference margin to be provided, emission power, and a geographical location of the second priority level secondary user participating in the coordination.

Another first priority level secondary user may determine whether the aggregate interferences generated by the joining of the requester exceed its own interference threshold based on the content of coordination.

The above method corresponds to the electronic device 200 in the third embodiment. The specific details may be referred to the third embodiment and will not be repeated here.

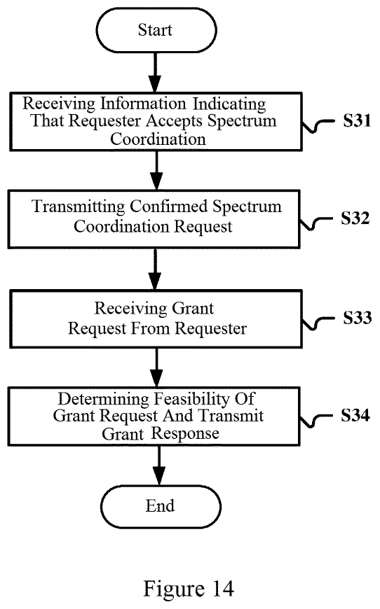

FIG. 14 shows a flow chart of a method for a first priority level secondary user according to an embodiment of the present application. As shown in FIG. 14, the method includes: receiving, from a second priority level secondary user who is a requester for spectrum resources, information indicating that the requester accepts spectrum coordination (S31); through spectrum coordination, other second priority level secondary users who are using spectrum resources perform coordination to provide an interference margin for the requester; and sending a spectrum coordination request confirmed by a spectrum management apparatus to the requester (S32). The method can be performed, for example, on the spectrum management apparatus side.

For example, the spectrum coordination request includes signature information of the spectrum management apparatus, and the spectrum coordination request also includes one or more of the requested frequency band, emission power, and geographical location of the requester.

As shown in the dotted line block in FIG. 14, the method may further include a step S33: receiving a grant request from a requester (S33), the grant request at least including the content of coordination to be performed by the second priority level secondary users who are utilizing the spectrum resources. The content of coordination, for example, includes one or more of an identifier, an interference margin to be provided, emission power, and a geographical location of the second priority level secondary user participating in the coordination.

In one example, the grant request further includes information that the affected first priority level secondary user affected by the joining of the requester agrees to increase its own interference threshold.

Although not shown, the method may further include the steps of: marking the affected first priority level secondary user; and canceling the marking of the marked first priority level secondary user after it gets compensation.

As shown in another dotted line block in FIG. 14, the above method may also include a step S34: determining the feasibility of the grant request, and sending a grant success response to the requester if the grant request is feasible, and sending a grant failure response to the requester if the grant request is not feasible.

In addition, although not shown in the figure, the above method may also include: receiving a notification from a first priority level secondary user whose subjected interferences exceed its own interference threshold, and determining a second priority level secondary user that has committed violation behaviors and caused harmful interferences to the first priority level secondary user based on the operating parameters of the currently operating second priority level secondary users. The above method may also include: sending the identifier of the determined second priority level secondary user that has committed violation behaviors to the first priority level secondary user whose subjected interferences exceed its own interference threshold and/or a block chain composed of second priority level secondary users.

The above method corresponds to the electronic device 300 in the fourth embodiment. The specific details may be referred to the fourth embodiment and will not be repeated here.

Note that the above methods can be used in combination or individually.

The technology of the present disclosure can be applied to various products.

For example, the electronic devices 100 and 200 may be implemented as various base stations. The base station may be implemented as any type of evolved Node B (eNB) or gNB (5G base station). The eNB includes, for example, a macro eNB and a small eNB. A small eNB may be an eNB that covers a cell smaller than a macro cell, such as a pico eNB, a micro eNB, and a home (femto) eNB. Similar situations may also apply to gNBs. Alternatively, the base station may be implemented as any other type of base station, such as a NodeB and a base transceiver station (BTS). The base station may include: a main body (also referred to as a base station device) configured to control wireless communications; and one or more remote radio heads (RRHs) arranged at a different place from the main body. In addition, various types of user equipment may work as a base station by temporarily or semi-persistently performing base station functions.

For example, the electronic device 300 can be implemented as any type of server, such as a tower server, a rack server, and a blade server. The electronic device 300 can be a control module installed on the server (such as an integrated circuit module including a single chip, and a card or blade inserted into a slot of a blade server).

### [Application Example Regarding Base Station]

### First Application Example

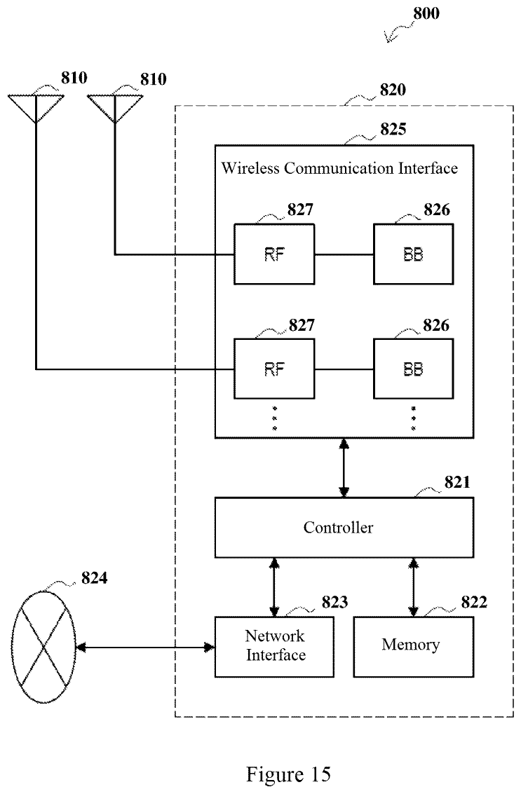

FIG. 15 is a block diagram illustrating a first example of a schematic configuration of an eNB or gNB to which the technology of the present disclosure may be applied. Note that the following description takes eNB as an example, but may also be applied to gNB. An eNB 800 includes one or more antennas 810 and a base station device 820. The base station device 820 and each antenna 810 may be connected to each other via an RF cable.

Each of the antennas 810 includes a single or multiple antenna elements (such as multiple antenna elements included in a Multiple Input Multiple Output (MIMO) antenna), and is used for the base station device 820 to transmit and receive wireless signals. The eNB 800 may include multiple antennas 810, as illustrated in FIG. 15. For example, the multiple antennas 810 may be compatible with multiple frequency bands used by the eNB 800. Although FIG. 15 illustrates an example in which the eNB 800 includes the multiple antennas 810, the eNB 800 may also include a single antenna 810.

The base station device 820 includes a controller 821, a memory 822, a network interface 823, and a wireless communication interface 825.

The controller 821 may be, for example, a CPU or a DSP, and operates various functions of a higher layer of the base station device 820. For example, the controller 821 generates a data packet from data in signals processed by the wireless communication interface 825, and transfers the generated packet via the network interface 823. The controller 821 may bundle data from multiple base band processors to generate the bundled packet, and transfer the generated bundled packet. The controller 821 may have logical functions of performing control such as radio resource control, radio bearer control, mobility management, admission control, and scheduling. The control may be performed in conjunction with an eNB or core network node in the vicinity. The memory 822 includes RAM and a ROM, and stores a program that is executed by the controller 821, and various types of control data (such as a terminal list, transmission power data, and scheduling data).

The network interface 823 is a communication interface for connecting the base station device 820 to a core network 824. The controller 821 may communicate with a core network node or another eNB via the network interface 823. In this case, the eNB 800 and the core network node or other eNBs may be connected to each other through a logical interface (such as an S1 interface and an X2 interface). The network interface 823 may also be a wired communication interface or a wireless communication interface for a wireless backhaul line. If the network interface 823 is a wireless communication interface, the network interface 823 may use a higher frequency band for wireless communication than a frequency band used by the wireless communication interface 825.

The wireless communication interface 825 supports any cellular communication scheme such as Long Term Evolution (LTE) and LTE-Advanced, and provides wireless connection to a terminal positioned in a cell of the eNB 800 via the antenna 810. The wireless communication interface 825 may typically include, for example, a baseband (BB) processor 826 and an RF circuit 827. The BB processor 826 may perform, for example, encoding/decoding, modulation/demodulation, and multiplexing/demultiplexing, and perform various types of signal processing of layers (such as L1, medium access control (MAC), radio link control (RLC), and a packet data convergence protocol (PDCP)). Instead of the controller 821, the BB processor 826 may have a part or all of the above-mentioned logical functions. The BB processor 826 may be a memory that stores a communication control program, or a module that includes a processor and a related circuit configured to execute the program. Updating the program may allow the functions of the BB processor 826 to be changed. The module may be a card or a blade that is inserted into a slot of the base station device 820. Alternatively, the module may also be a chip that is mounted on a card or a blade. Meanwhile, the RF circuit 827 may include, for example, a mixer, a filter, and an amplifier, and transmits and receives wireless signals via the antenna 810.

The wireless communication interface 825 may include the multiple BB processors 826, as illustrated in FIG. 15. For example, the multiple BB processors 826 may be compatible with multiple frequency bands used by the eNB 800. The wireless communication interface 825 may include the multiple RF circuits 827, as illustrated in FIG. 15. For example, the multiple RF circuits 827 may be compatible with multiple antenna elements. Although FIG. 15 illustrates the example in which the wireless communication interface 825 includes the multiple BB processors 826 and the multiple RF circuits 827, the wireless communication interface 825 may also include a single BB processor 826 or a single RF circuit 827.

In the eNB 800 as illustrated in FIG. 15, the acquisition unit 101 and transceiver of the electronic device 100 and the receiving unit 201, the transmitting unit 202 and the transceiver of the electronic device 200 may be implemented by the wireless communication interface 825. At least a part of the functions may also be implemented by the controller 821. For example, the controller 821 may cause the second priority level secondary users who are using the spectrum resources to perform coordination to provide the corresponding interference margin by executing the functions of the acquisition unit 101 and the execution unit 102, so that the new second priority level secondary users can successfully access in the spectrum resources, thereby improving the efficiency of dynamic spectrum sharing; the controller 821 may perform the interference coordination among multiple first priority level secondary users by executing the functions of the receiving unit 201 and the transmitting unit 202, thereby improving the performance of dynamic spectrum sharing.

### Second Application Example

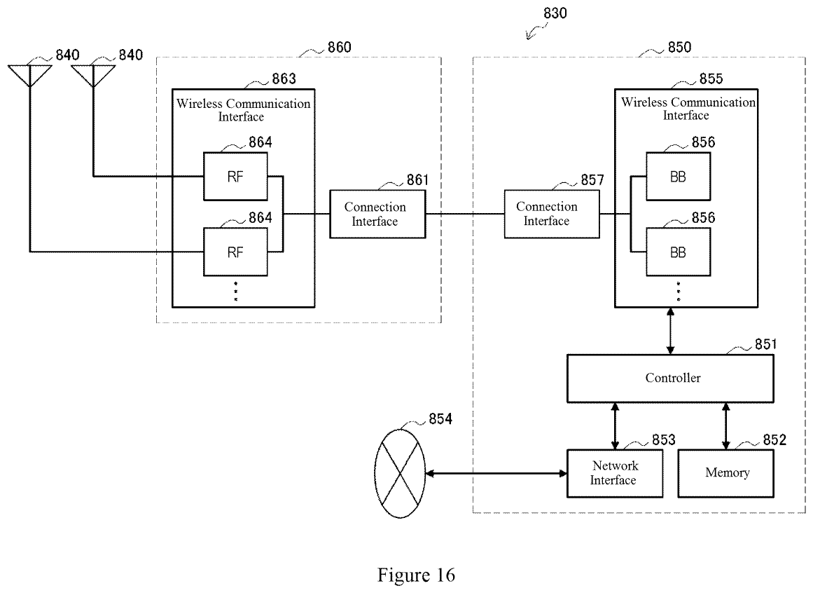

FIG. 16 is a block diagram illustrating a second example of a schematic configuration of an eNB or gNB to which the technology of the present disclosure may be applied. Note that similarly, the following description takes the eNB as an example, but may also be applied to the gNB. An eNB 830 includes one or more antennas 840, a base station device 850, and an RRH 860. The RRH 860 and each antenna 840 may be connected to each other via an RF cable. The base station device 850 and the RRH 860 may be connected to each other via a high-speed line such as an optical fiber cable.

Each of the antennas 840 includes a single or multiple antenna elements (such as multiple antenna elements included in an MIMO antenna), and is used for the RRH 860 to transmit and receive wireless signals. The eNB 830 may include multiple antennas 840, as illustrated in FIG. 16. For example, the multiple antennas 840 may be compatible with multiple frequency bands used by the eNB 830. Although FIG. 16 illustrates the example in which the eNB 830 includes the multiple antennas 840, the eNB 830 may also include a single antenna 840.

The base station device 850 includes a controller 851, a memory 852, a network interface 853, a wireless communication interface 855, and a connection interface 857. The controller 851, the memory 852, and the network interface 853 are the same as the controller 821, the memory 822, and the network interface 823 described with reference to FIG. 15.

The wireless communication interface 855 supports any cellular communication scheme such as LTE and LTE-Advanced, and provides wireless communication to a terminal positioned in a sector corresponding to the RRH 860 via the RRH 860 and the antenna 840. The wireless communication interface 855 may typically include, for example, a BB processor 856. The BB processor 856 is the same as the BB processor 826 described with reference to FIG. 15, except the BB processor 856 is connected to the RF circuit 864 of the RRH 860 via the connection interface 857. The wireless communication interface 855 may include a plurality of BB processors 856, as illustrated in FIG. 16. For example, the multiple BB processors 856 may be compatible with multiple frequency bands used by the eNB 830. Although FIG. 16 illustrates the example in which the wireless communication interface 855 includes the multiple BB processors 856, the wireless communication interface 855 may also include a single BB processor 856.

The connection interface 857 is an interface for connecting the base station device 850 (wireless communication interface 855) to the RRH 860. The connection interface 857 may also be a communication module for communication in the above-described high speed line that connects the base station device 850 (wireless communication interface 855) to the RRH 860.

The RRH 860 includes a connection interface 861 and a wireless communication interface 863.

The connection interface 861 is an interface for connecting the RRH 860 (wireless communication interface 863) to the base station device 850. The connection interface 861 may also be a communication module for communication in the above-mentioned high-speed line.

The wireless communication interface 863 transmits and receives wireless signals via the antenna 840. The wireless communication interface 863 may typically include, for example, the RF circuit 864. The RF circuit 864 may include, for example, a mixer, a filter, and an amplifier, and transmits and receives wireless signals via the antenna 840. The wireless communication interface 863 may include multiple RF circuits 864, as illustrated in FIG. 16. For example, the multiple RF circuits 864 may support multiple antenna elements. Although FIG. 16 illustrates the example in which the wireless communication interface 863 includes the multiple RF circuits 864, the wireless communication interface 863 may also include a single RF circuit 864.

In the eNB 830 illustrated in FIG. 16, the acquisition unit 101 and transceiver of the electronic device 100 and the receiving unit 201, the transmitting unit 202 and the transceiver of the electronic device 200 may be implemented by the wireless communication interface 855 and/or the wireless communication interface 863. At least a part of the functions may also be implemented by the controller 851. For example, the controller 851 may cause the second priority level secondary users who are using the spectrum resources to perform coordination to provide the corresponding interference margin by executing the functions of the acquisition unit 101 and the execution unit 102, so that the new second priority level secondary users can successfully access in the spectrum resources, thereby improving the efficiency of dynamic spectrum sharing; the controller 851 may perform the interference coordination among multiple first priority level secondary users by executing the functions of the receiving unit 201 and the transmitting unit 202, thereby improving the performance of dynamic spectrum sharing.

### [Application Examples Regarding Server]

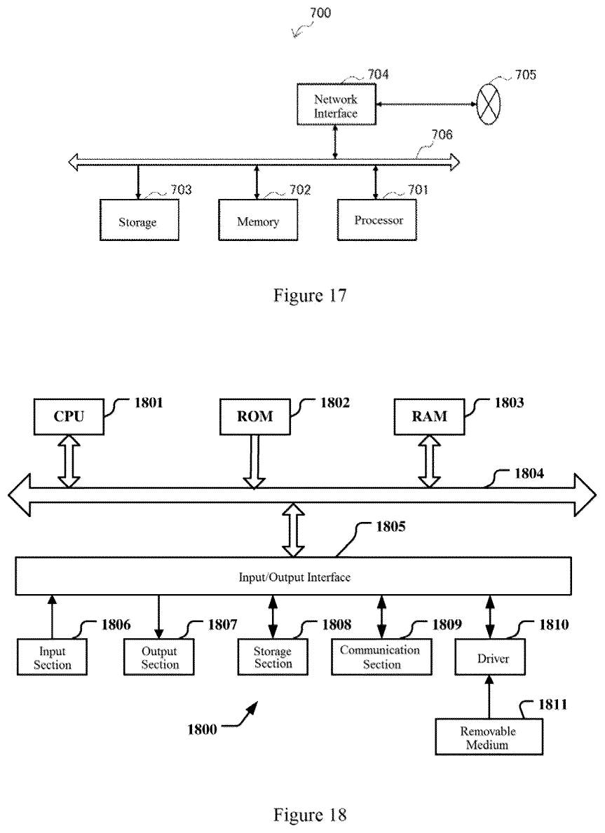

FIG. 17 is a block diagram illustrating an example of a schematic configuration of a server 700 to which the technology of the present disclosure can be applied. The server 700 includes a processor 701, a memory 702, a storage 703, a network interface 704, and a bus 706.

The processor 701 may be, for example, a central processing unit (CPU) or a digital signal processor (DSP), and controls functions of the server 700. The memory 702 includes a random access memory (RAM) and a read-only memory (ROM), and stores data and programs that are executed by the processor 701. The storage 703 may include a storage medium such as a semiconductor memory and a hard disk.

The network interface 704 is a wired communication interface for connecting the server 700 to the wired communication network 705. The wired communication network 705 may be a core network such as an evolved packet core network (EPC) or a packet data network (PDN) such as the Internet.

The bus 706 connects the processor 701, the memory 702, the storage 703, and the network interface 704 to each other. The bus 706 may include two or more buses each having a different speed, such as a high-speed bus and a low-speed bus.

In the server 700 illustrated in FIG. 17, the receiving unit 301, the transmitting unit 302, and the determination unit 303 described with reference to FIG. 10 and FIG. 11 may be implemented by the processor 701. For example, the processor 701 may cause the second priority level secondary users who are using the spectrum resources to perform coordination to provide the corresponding interference margin by executing the functions of the receiving unit 301, the transmitting unit 302, and the determination unit 303, so that the new second priority level secondary user can successfully access in the spectrum resources, thereby improving the efficiency of dynamic spectrum sharing.

The basic principles of the present disclosure are described above in conjunction with specific embodiments. However, it should be pointed out that for those skilled in the art, it is understandable that all or any steps or components of the methods and apparatus of the present disclosure can be implemented in any computing apparatus (including processors, storage media, etc.) or a network of computing devices in the form of hardware, firmware, software, or a combination thereof. This can be achieved by those skilled in the art using their basic circuit design knowledge or basic programming skills after reading the description of the present disclosure.

Furthermore, the present disclosure also proposes a program product storing machine-readable instruction codes. When the instruction codes are read and executed by a machine, the method according to the embodiment of the present disclosure can be executed.

Accordingly, the storage medium for carrying the program product storing the machine-readable instruction code is also included in the disclosure of the present disclosure, including but not limited to a floppy disk, an optical disk, a magneto-optical disk, a memory card, a memory stick, and the like.

When the present disclosure is implemented through software or firmware, the programs constituting the software are installed from a storage medium or a network to a computer with a dedicated hardware structure (such as the general-purpose computer 1800 shown in FIG. 18). When various programs are installed on the computer, it can perform various functions, etc.

In FIG. 18, a central processing unit (CPU) 1801 performs various processes according to a program stored in a read-only memory (ROM) 1802 or a program loaded from a storage section 1808 to a random access memory (RAM) 1803. In the RAM 1803, data required when the CPU 1801 performs various processes and the like is also stored as needed. The CPU 1801, the ROM 1802, and the RAM 1803 are connected to each other via a bus 1804. An input/output interface 1805 is also connected to the bus 1804.

The following components are connected to the input/output interface 1805: an input section 1806 (including a keyboard, a mouse, etc.), an output section 1807 (including a display such as a cathode ray tube (CRT), a liquid crystal display (LCD), etc., and a speaker, etc.), a storage section 1808 (including a hard disk, etc.), a communication section 1809 (including a network interface card such as a LAN card, a modem, etc.). The communication section 1809 performs communication processing via a network such as the Internet. A drive 1810 may also be connected to the input/output interface 1805 as needed. A removable medium 1811 such as a magnetic disk, an optical disk, a magneto-optical disk, a semiconductor memory, etc. is installed on the drive 1810 as needed, so that a computer program read therefrom is installed in the storage section 1808 as needed.

In the case where the above-described series of processing is realized by software, a program constituting the software is installed from a network such as the Internet or a storage medium such as the removable medium 1811.

It should be understood by those skilled in the art that such storage medium is not limited to the removable medium 1811 shown in FIG. 18 in which the program is stored and distributed separately from the device to provide the program to the user. Examples of the removable medium 1811 include magnetic disks (including floppy disks (registered trademark)), optical disks (including compact disk read-only memory (CD-ROM) and digital versatile disks (DVD)), magneto-optical disks (including minidiscs (MD) (registered trademark)), and semiconductor memories. Alternatively, the storage medium may be a ROM 1802, a hard disk included in the storage portion 1808, or the like, in which the program is stored and distributed to the user together with the device containing them.

It should also be noted that in the apparatus, method and system of the present disclosure, each component or each step can be decomposed and/or recombined. These decompositions and/or recombinations should be regarded as equivalent schemes of the present disclosure. In addition, the steps of performing the above series of processing can naturally be performed in chronological order according to the order of description, but do not necessarily need to be performed in chronological order. Some steps can be performed in parallel or independently of each other.

Finally, it should be noted that the terms “comprises”, “includes” or any other variants thereof are intended to cover non-exclusive inclusion, so that a process, method, article or device including a series of elements includes not only those elements, but also other elements not explicitly listed, or also includes elements inherent to such process, method, article or device. In addition, in the absence of more restrictions, an element defined by the sentence “comprises a . . . ” does not exclude the presence of other identical elements in the process, method, article or device including the element.

Although the embodiments of the present disclosure are described in detail above in conjunction with the accompanying drawings, it should be understood that the embodiments described above are only used to illustrate the present disclosure and do not constitute a limitation of the present disclosure. For those skilled in the art, various modifications and changes can be made to the above embodiments without departing from the essence and scope of the present disclosure. Therefore, the scope of the present disclosure is limited only by the attached claims and their equivalent meanings.

1. An electronic device for a second priority level secondary user in a dynamic spectrum sharing system, the dynamic spectrum sharing system comprising a primary user, a first priority level secondary user and the second priority level secondary user, the first priority level secondary user and the second priority level secondary user utilize spectrum resources of the primary user dynamically, and the first priority level is higher than the second priority level in terms of utilizing the spectrum resources of the primary user, the electronic device comprising:
at least one processor; and
at least one memory including computer program code, where the at least one memory and the computer program code are configured, with the at least one processor, to cause the electronic device to:
acquire, based on a block chain, a spectrum coordination request from another second priority level secondary user as a requester for the spectrum resources, which is confirmed by a spectrum management apparatus, wherein the block chain at least includes each second priority level secondary user which is utilizing the spectrum resources or requesting to utilize the spectrum resources as a node, and the spectrum coordination request indicates that the requester requests second priority level secondary users which are utilizing the spectrum resources to perform coordination so as to provide an interference margin for the requester; and
execute a first smart contract on the block chain, so as to determine content of coordination to be performed.

2. The electronic device according to claim 1, wherein the content of coordination comprises one or more of an identifier, the interference margin to be provided, emission power, and a geographical location of a second priority level secondary user taking part in the coordination,
wherein the spectrum coordination request comprises signature information of the spectrum management apparatus.
wherein the spectrum coordination request further comprises one or more of the requested frequency band, emission power and geographical location of the requester.

3. (canceled)

4. The electronic device according to claim 1, wherein the requester sends a grant request at least containing the content of coordination to the spectrum management apparatus, and the at least one memory and the computer program code are further configured, with the at least one processor, to cause the electronic device to execute a second smart contract in response to a grant success response from the spectrum management apparatus, so that the second priority level secondary user taking part in the coordination reduces the emission power according to the content of coordination.

5. The electronic device according to claim 4, wherein the at least one memory and the computer program code are further configured, with the at least one processor, to cause the electronic device to execute the second smart contract to calculate the coordination factor value of the second priority level secondary user taking part in the coordination, to evaluate contribution of the corresponding second priority level secondary user to the interference margin; and/or
wherein the requester sends the content of coordination to the nearest first priority level secondary user which forwards it to other first priority level secondary users which are utilizing the spectrum resources; the nearest first priority level secondary user receives, from an affected first priority level secondary user, information of whether to agree to increase its own interference threshold, and forwards the information to the requester; and the grant request also includes information that the affected first priority level secondary user agrees to increase its own interference threshold.

6. (canceled)

7. The electronic device of claim 2, wherein the at least one memory and the computer program code are configured, with the at least one processor, to cause the electronic device to execute the first smart contract, so as to determine the second priority level secondary users taking part in the coordination according to trust values of the second priority level secondary users which agree to take part in the coordination.

8. The electronic device according to claim 7, wherein the trust value is determined based on the activity degree of the corresponding second priority level secondary user in taking part in the coordination and/or the occurrence frequency of violation behaviors,
wherein the at least one memory and the computer program code are configured, with the at least one processor, to cause the electronic device to execute a third smart contract on the block chain, so as to update the trust value.

9. (canceled)

10. The electronic device according to claim 8, wherein the at least one memory and the computer program code are configured, with the at least one processor, to cause the electronic device to receive a list of second priority level secondary users which have committed the violation behaviors from the spectrum management apparatus, and execute the third smart contract in response to the receiving.

11. The electronic device according to claim 1, wherein the processing circuitry is further configured to determine, based on comprehensive contribution degrees of respective second priority level secondary users in a coordination process, a second priority level secondary user as an accounting node on the block chain, the accounting node generating a block.

12. The electronic device according to claim 11, wherein the block comprises specific content of the spectrum coordination and the comprehensive contribution degrees of respective second priority level secondary users in the coordination process; and
wherein the comprehensive contribution degree includes a coordination factor value and a trust value, the coordination factor value indicating the contribution of the corresponding second priority level secondary user to the interference margin, and the trust value indicating the activity degree of the corresponding second priority level secondary user in taking part in the coordination and/or the occurrence frequency of violation behaviors.

13. The electronic device according to claim 12, wherein the specific content of the spectrum coordination includes: information on the interference margin provided by the second priority level secondary user taking part in the coordination by reducing its own emission power, and the time point when the coordination process ends.

14. The electronic device according to claim 11, wherein the at least one memory and the computer program code are configured, with the at least one processor, to cause the electronic device to divide respective second priority level secondary users into a first level and a second level according to the comprehensive contribution degrees, and preferentially determine the second priority level secondary user in the first level as the accounting node, wherein the comprehensive contribution degree of the second priority level secondary user in the first level is higher than the comprehensive contribution degree of the second priority level secondary user in the second level.

15. (canceled)

16. The electronic device according to claim 1, wherein the dynamic spectrum sharing system is a citizen broadband radio service system, the primary user is an incumbent, the first priority level secondary user is a priority access license user, and the second priority level secondary user is a general authorized access user.

17. An electronic device for a first priority level secondary user in a dynamic spectrum sharing system, the dynamic spectrum sharing system comprising a primary user, a first priority level secondary user and the second priority level secondary user, the first priority level secondary user and the second priority level secondary user utilize spectrum resources of the primary user dynamically, and the first priority level is higher than the second priority level in terms of utilizing the spectrum resources of the primary user, the electronic device comprising:
at least one processor; and
at least one memory including computer program code, where the at least one memory and the computer program code are configured, with the at least one processor, to cause the electronic device to:
receive, from a second priority level secondary user as a requester for the spectrum resources, content of coordination to be performed by another second priority level secondary user taking part in the coordination, wherein the requester requests other second priority level secondary users which are utilizing the spectrum resources to perform coordination so as to provide an interference margin for the requester:
forward the content of coordination to another first priority level secondary user utilizing the spectrum resources:
receive, from affected another first priority level secondary user, information of whether to agree to increase an interference threshold of its own; and
transmit a response to the requester based on the information.

18. The electronic device according to claim 17, wherein the content of coordination comprises one or more of an identifier, an interference margin to be provided, emission power, and a geographical location of a second priority level secondary user taking part in the coordination; and/or
wherein another first priority level secondary user determines whether the aggregate interferences generated by the joining of the requester exceed its own interference threshold based on the content of coordination.

19.-20. (canceled)

21. An electronic device for a spectrum management apparatus in a dynamic spectrum sharing system, the dynamic spectrum sharing system comprising a primary user, a first priority level secondary user and a second priority level secondary user, the first priority level secondary user and the second priority level secondary user utilize spectrum resources of the primary user dynamically, and the first priority level is higher than the second priority level in terms of utilizing the spectrum resources of the primary user, the electronic device comprising:
at least one processor; and
at least one memory including computer program code, where the at least one memory and the computer program code are configured, with the at least one processor, to cause the electronic device to:
receive, from a second priority level secondary user as a requester for the spectrum resources, information indicating that the requester accepts spectrum coordination, through which other second priority level secondary users which are utilizing the spectrum resources perform coordination so as to provide an interference margin for the requester; and
transmit a spectrum coordination request confirmed by the spectrum management apparatus to the requester.

22. The electronic device according to claim 21, wherein the spectrum coordination request includes signature information of the spectrum management apparatus,
wherein the spectrum coordination request further includes one or more of a requested frequency band, emission power and a geographical location of the requester.

23. The electronic device according to claim 21, wherein the at least one memory and the computer program code are further configured, with the at least one processor, to cause the electronic device to receive a grant request from the requester, the grant request at least comprising content of coordination to be performed by the second priority level secondary users which are utilizing the spectrum resources,
wherein the content of coordination comprises one or more of an identifier, an interference margin to be provided, emission power, and a geographical location of a second priority level secondary user taking part in the coordination.

24. (canceled)

25. The electronic device according to claim 23, wherein the grant request further comprises information that the affected first priority level secondary user affected by the joining of the requester agrees to increase its own interference threshold,
wherein the at least one memory and the computer program code are further configured, with the at least one processor, to cause the electronic device to mark the affected first priority level secondary users, and remove the marking of the marked first priority level secondary user after it gets compensation.

26.-27. (canceled)

28. The electronic device according to claim 23, wherein the at least one memory and the computer program code are configured, with the at least one processor, to cause the electronic device to determine the feasibility of the grant request, and send a grant success response to the requester if the grant request is feasible, and send a grant failure response to the requester if the grant request is not feasible.

29. The electronic device according to claim 28, wherein the at least one memory and the computer program code are further configured, with the at least one processor, to cause the electronic device to:
receive a notification from a first priority level secondary user whose interferences exceed its own interference threshold, and to determine a second priority level secondary user that has committed violation behaviors and caused harmful interferences to the first priority level secondary user based on operating parameters of currently operating second priority level secondary users, and
send the identifier of the second priority level secondary user which has committed the violation behaviors to the first priority level secondary user whose subjected interferences exceed its own interference threshold and/or the block chain composed of the second priority level secondary users.

30.-35. (canceled)
